(19) United States
(12) Patent Application Publication
(10) Pub. No.: US 2009/0065424 A1
(43) Pub. Date: Mar. 12, 2009

(54) CIRCULAR CENTRIFUGATION CHAMBER FOR SEPARATION OF BLOOD

(76) Inventor: Jean-Denis Rochat, Genolier (CH)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 12/280,093

(22) PCT Filed: Feb. 19, 2007
(86) PCT No.: PCT/CH07/00086

§ 371 Date: Aug. 20, 2008

(30) Foreign Application Priority Data
Feb. 23, 2006 (EP) 06405078.4

(51) Int. Cl. B01D 21/26; B01D 33/06

(52) U.S. Cl. 210/380.3; 210/512.3

(57) ABSTRACT

One of the ends of this chamber has sealing means and is traversed by an intake channel for the blood that is to be centrifuged, and by at least one discharge channel). At least one circular deflector, concentric to the axis of revolution, is situated between the outlet of the intake channel and the admission port of the discharge channel in order to form an axial flow of the blood with a current counter to that formed against the lateral wall. This deflector has an alternating sequence of contiguous concave parts and convex parts that have or define between them crest lines or thalweg lines, at least some of these lines being inclined in the direction of the axis of revolution of the chamber.

The present invention relates to a circular centrifuge chamber for the separation of blood, this chamber being elongated along its axis of revolution and one of its ends having means for sealing and for maintaining sterility inside the chamber, surrounding a fixed portion concentric with its axis of revolution and traversed by a feed channel for the blood to be centrifuged and at least one discharge channel for the constituent separated from the blood whose density is the lowest, these feed and discharge channels being designed to be connected to means for circulating the blood from one to the other through the centrifuge chamber while forming an axial flow against the circular side wall of this chamber, the inlet opening of said discharge channel being at a distance from said axis of revolution corresponding to the zone of concentration of said separated constituent whose density is the lowest in order to continuously remove it, at least one circular deflector being situated between the outlet of the feed channel and the inlet opening of the discharge channel in order to form an axial flow of the blood with a counter-current of that formed against said side wall.

Current centrifuge chambers have a separation power limited by two main parameters:

The speed of rotation: it is limited by the risks of hemolysis of the red blood cells, of heating of the blood, by the mechanical forces or the noise level that it generates, or else in order to ensure the safety of the user.

The space requirement: small-dimension centrifuge chambers have the advantage of being able to turn at a high rotation speed, but offer a centrifuge radius R_{f} of small dimensions, and a reduced effective separation surface area S. Large-dimension centrifuges make it possible to work over a large centrifuge radius R_{f}, and to have a considerable effective separation surface area S. They are on the other hand limited in rotation speed and have the major disadvantage of being bulky, increasing storage volumes and requiring a large-dimension centrifuge machine.

A centrifuge chamber of the abovementioned type has already been proposed in U.S. Pat. No. 3,145,713, but with exclusively discontinuous operation, since, after the separation of a certain volume, determined by the volume of the enclosure, the red blood cells are removed by being aspirated through the whole blood inlet. In this enclosure, the liquid passes from an external separation compartment to an internal separation compartment which goes against the centrifugal force. In addition, nothing is provided so that the constituents that are already separated do not mix together again during the passage from one separation compartment to the other of this centrifuging enclosure. Consequently, the lengthening of the path traveled by the liquid to be separated practically does not contribute to improving the separating power of the centrifuge chamber.

The method described in U.S. Pat. No. 6,352,499 is also discontinuous, as in the previous solution and the enclosure described does not have means for preventing the remixing of the constituents between the first compartment and the second compartment.

Finally, U.S. Pat. No. 6,629,919 and JP 59-069166 both relate to discontinuous centrifuging enclosures comprising two separation compartments, a first for the separation of the red blood cells and the plasma and a second for purifying the plasma. These enclosures do not make it possible to increase the separation surface area on which the process of separation of all the blood constituents takes place, but make it possible to carry out a separation in stages, each stage serving to separate a specific constituent, the constituent (the red blood cells) separated in the first stage not passing into the second compartment. Such enclosures, as will be explained below, do not make it possible to increase the effective surface area for the separation of a continuous flow of blood and to optimize both the volume of the enclosure and its separating power.

The object of the present invention is to remedy, at least in part, the disadvantages of these solutions.

Accordingly, the subject of this invention is a circular centrifuge chamber for the separation of blood of the type mentioned above in which the circular deflector has alternating adjacent concave portions and convex portions that have or define between them crest or thalweg lines of which at least a portion of these lines are inclined in the direction of the axis of revolution of the chamber.

The concept of the proposed centrifuge chamber consists in combining the advantages of centrifuge chambers that have small dimension, consequently being able to rotate at high speed, while having a considerable effective separation surface area S thanks to the presence of several stages of separation and to the passage from one stage to the other without remixing the constituents already at least partially separated. This makes it possible to optimize the separation power of the centrifuge chamber, and finally to have a maximum flow of blood to be separated (and therefore to reduce the separation time of a given volume of whole blood).

The appended drawings illustrate schematically and as an example a form of execution and various variants of the circular centrifuge chamber for the separation of blood that is the subject of the present invention.

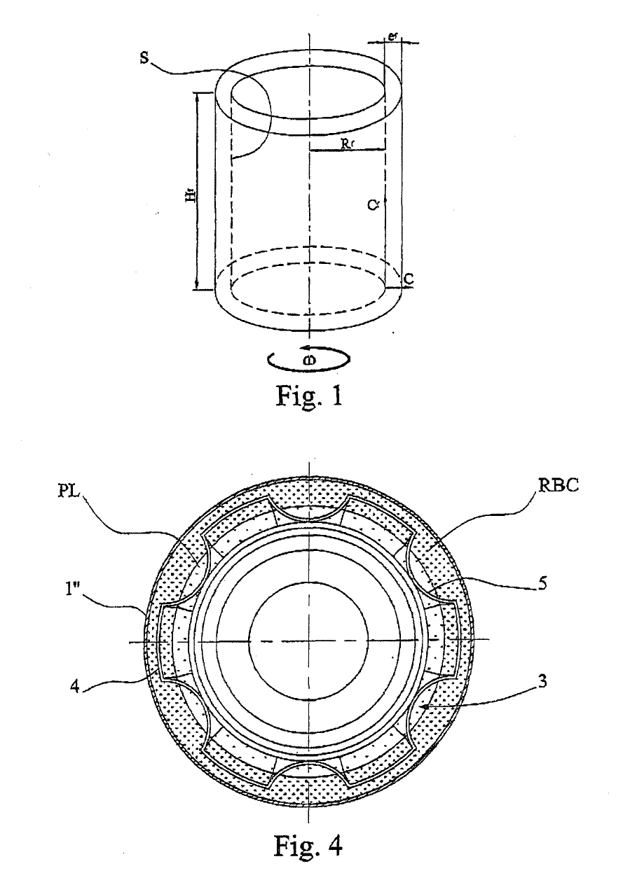

FIG. 1 is, for explanatory purposes, a view in perspective of a centrifuge chamber on which the various parameters used in the general explanation of the concept of the invention are marked;

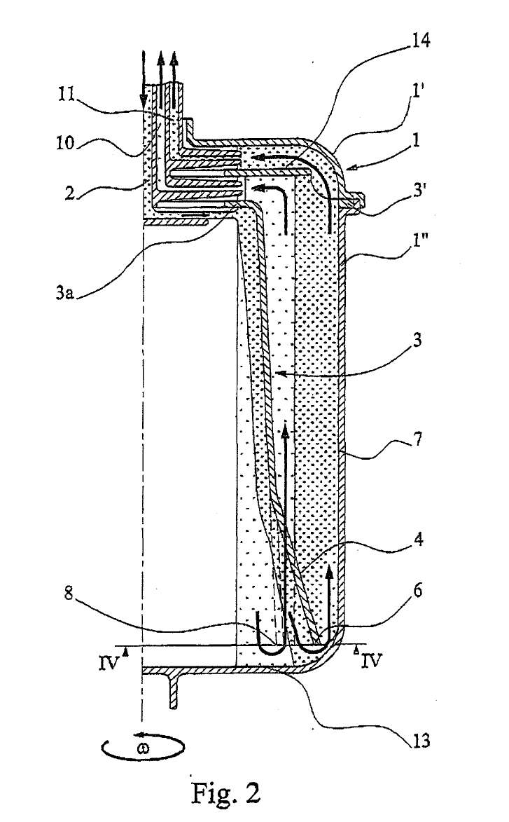

FIG. 2 is a view in diametral section of the form of execution of the invention, showing only half of the centrifuge chamber;

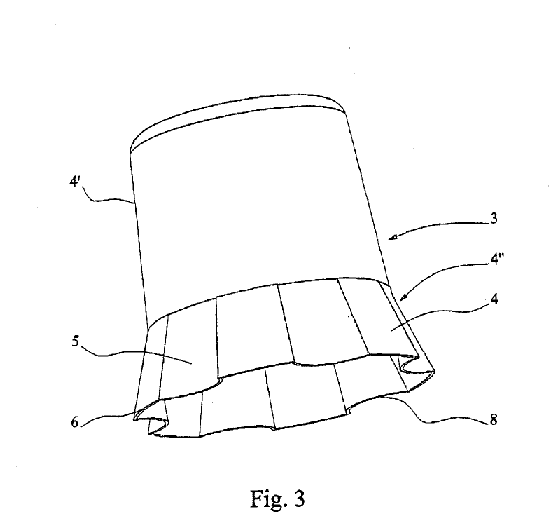

FIG. 3 is a view in perspective of a detail of the centrifuge chamber of FIG. 2;

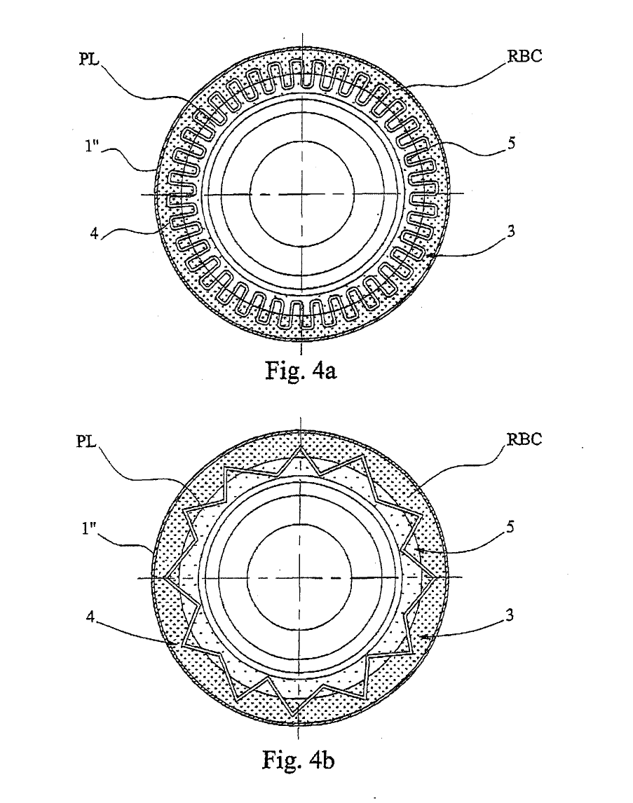

FIG. 4 is a view in section along the line IV-IV of FIG. 2;

FIGS. 4a and 4b are views similar to that of FIG. 4 and illustrate respectively a first and a second variant embodiment of the cylindrical deflector of the centrifuge chamber;

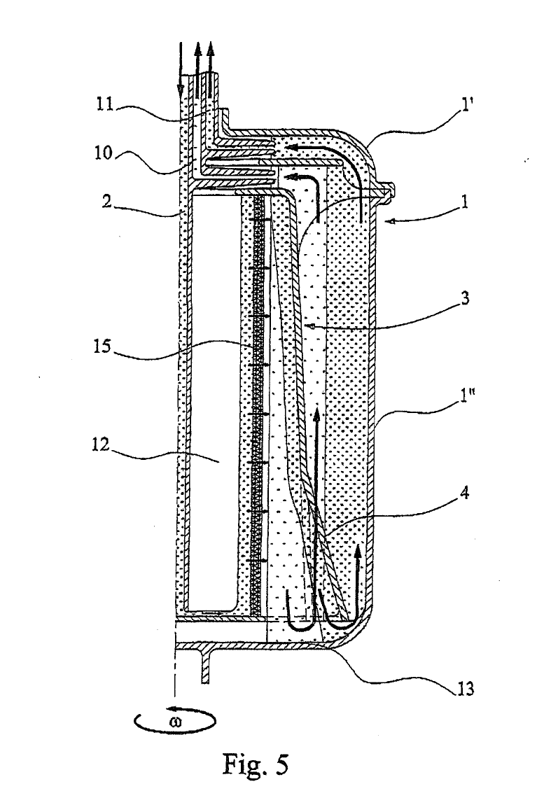

FIG. 5 is a view similar to FIG. 2 of a variant of the centrifuge chamber.

During the separation of the blood constituents by centrifuging, the speed of sedimentation of a particle (red blood cell, leucocyte, platelet) in the plasma is given by the balance of the centrifugal forces and of the viscosity forces that act on the particle.

With reference mainly to the parameters indicated in FIG. 1, assume:
F_{c}=centrifugal force [N]
Fᵥ=viscosity force [N]
ω=speed of rotation of the centrifuge [rad/s]
R_{f}=radius of centrifuging of the particle (distance from the center of gravity of the particle to the axis of rotation) [m]
Rₚ=radius of the particle [m]
Vₚ=volume of the particle [m³]
ρₚ=density of the particle [kg/m³]
ρₚ₁ₐ=density of the plasma [kg/m³]
ηₚ₁ₐ=viscosity of the plasma [kg/(m.s)]
C=speed of sedimentation of the particle

The centrifugal force applied to the particle is given by the following formula:

F_{c}=(ρₚ−ρₚ₁ₐ)·Vₚ·ω²·R_{f} \textcircled{1}
[N]

The viscosity force that opposes the centrifugal force is given by the formula:

Fᵥ=6·π·Rₚ·ηₚ₁ₐC \textcircled{2}
[N]

When the system is in equilibrium, F_{c}=Fᵥ. It is therefore possible to draw therefrom that:

$$C = \frac{( {ρ}_{p} - {ρ}_{pla} ) \cdot {V}_{p}}{6 \cdot π \cdot {R}_{p} \cdot {η}_{pla}} \cdot {ω}^{2} \cdot {R}_{f} [ m \text{/} s ] \qquad ( 3 )$$

In the case of a given particle immersed in a given fluid, the equation 3 becomes:

C=cste·ω²·R_{f} \textcircled{4}
[m/s]

The separating power of a centrifuge chamber defines the flow of fluid to be separated that it can absorb while achieving the desired sedimentation.

Assume a separation chamber traversed by a vertical annular liquid flow of speed C_{f}, of internal diameter R_{f}, of height H_{f} and whose fluid layer thickness is e_{f}.

For a particle that is at the entrance of the chamber on the least favorable radius R_{f} to have the time to sediment completely, it is necessary that:

$$\frac{{H}_{f}}{{C}_{f}} \geq \frac{{e}_{f}}{C} \qquad ( 5 )$$

[s]

Assume \dot{Q}[m³/s] is the flow passing through the centrifuge chamber. When R_{f}>>e_{f}, this gives:

$$\dot{Q} = {C}_{f} \cdot 2 \cdot π \cdot {R}_{f} \cdot {e}_{f} \leq C \cdot \frac{{H}_{f}}{{e}_{f }} \cdot 2 \cdot π \cdot {R}_{f} \cdot {e}_{f} \leq C \cdot {H}_{f} \cdot 2 \cdot π \cdot {R}_{f} [ {m}^{3} \text{/} s ] \qquad ( 6 )$$

Finally, by inserting 4 into 6, this gives:

\dot{Q}≦Cste·ω²•R_{f}·H_{f}·2·π·R_{f}=Cste·2·π·R_{f}·H·ω²·R_{f} \textcircled{7}
[m³/s]

It can be stated that:

2·πR_{f}·H_{f}=S
[m²]

S representing the effective surface area of the centrifuge chamber.

The formula 7 may therefore be written as follows:

\dot{Q}≦Cste·S·ω²R_{f} \textcircled{7}
[m³/s]

In view of this formula, it becomes clear that the parameters making it possible to have the separation power of a centrifuge chamber vary are:
1. The rotation speed of the centrifuge chamber ω.
2. The distance relative to the axis of rotation of the liquid to be centrifuged R_{f}.
3. The centrifuge chamber surface area S on which the separation forces are effectively used.

As has been said above, the proposed centrifuge chamber concept consists in combining the advantages of the centrifuge chambers that have a small dimension, consequently being able to rotate at high speed, while having a considerable effective separation surface area S.

The circular centrifuge chamber 1 illustrated by FIGS. 2 to 4 has the general shape of an elongated cylinder comprising two portions 1′, 1″, upper, respectively lower, that are made of thermoplastic and heat-sealed to one another, and it is traversed at its top end by a fixed portion centered on the axis of revolution of the centrifuge chamber 1, traversed by a whole blood WB feed duct 2 and, in this example, by two discharge ducts 10, 11 for the plasma PL, respectively for the red blood cells RBC. A system of sealing and of maintaining sterility, like a rotating seal (not shown), for example, well known in this type of centrifuge chamber, is placed between the fixed portion traversed by the ducts 2, 10, 11 and the rotating portion consisting of the cylindrical chamber 1. The ducts 2, 10, 11 are designed to be connected, in a known manner, to a patient and/or pouches for the collection and storage of the components, if necessary by means of circulation pumps (elements not shown).

The internal space of the centrifuge chamber 1 is divided by a circular deflector 3 that is able to be attached to this centrifuge chamber 1 by fins 31 sandwiched between the edges of the two portions 1′, 1″ heat-sealed to one another of this centrifuge chamber 1. This circular deflector 3 is preferably concentric with the axis of revolution of the centrifuge chamber 1. According to the preferred embodiment illustrated in detail in FIG. 3, this deflector comprises a circular surface 4′, preferably slightly conical, which terminates at its bottom portion situated at the downstream end of the deflector 3, in a second conical portion 4″ whose angle of conicity is more marked than that of the circular surface 4′. The surface of this second conical portion 4″ is interrupted by an alternation of concave portions 5 which hollow out progressively in the downstream axial direction, giving it, in plan view, the appearance of a gear wheel with truncated teeth, as illustrated by FIG. 4. The incorporation of the concave portions 5 into the surface of the second conical portion 4″ defines convex portions 4 alternating with the concave portions 5. The concave and convex portions are therefore fitted to the downstream perimeter of the circular surface 4′. The downstream middle parts of these concave portions 5 progressively re-entering toward the downstream are tangential to a common line that is preferably circular and concentric with the axis of revolution of the centrifuge chamber 1 and whose diameter is slightly greater than that of the junction between the circular surface 4′ and the second conical portion 4″ of the circular deflector 3, so as to ensure that the blood flows toward the bottom of the centrifuge chamber, over all of the internal faces of the concave portions 5 when the centrifuge chamber 1 rotates about its axis of revolution. The top upstream end of the deflector 3 terminates in an internal annular rim 3a in order to separate the whole blood WB that is entering from the separated components.

The two discharge ducts 10, 11 each have an inlet portion of radial orientation relative to the axis of revolution of the centrifuge chamber 1, in order to be immersed in the thickness of the separated layers of plasma PL and of red blood cells RBC in order to allow their extraction. A deflector, preferably in the shape of a smooth ring 14, concentric with the axis of revolution of the centrifuge chamber 1, is placed between the inlet ends of the discharge ducts 10 and 11 in order to prevent the mixing of these two constituents. Accordingly, the external diameter of the annular deflector 14 is greater than the diameter of the interface between the layer of red blood cells RBC which is the furthest from the axis of revolution of the centrifuge chamber 1 and which is adjacent to the side wall 7 of this centrifuge chamber and the layer of plasma PL situated between the layer of red blood cells and the outer face of the circular deflector 3. The internal diameter of this partition 14 is less than the internal diameter of the two layers of separated constituents.

The process of separation with the aid of the centrifuge chamber described above is as follows: the whole blood WB to be centrifuged is inserted into the centrifuge chamber 1 through the fixed channel 2. Under the effect of the centrifugal force, the whole blood WB is pressed against the top upstream end of the circular deflector 3. While flowing toward the bottom of the centrifuge chamber 1, the whole blood WB undergoes a first separation into plasma PL and into a concentrate of red blood cells RBC. The latter are pressed over the largest centrifuging radius because of their larger density and form a layer adjacent to the inner face of the circular deflector 3. The advantageously hollowed shape of the concave portions 5 progressively re-entering situated between the two convex portions 4 has the effect that the red blood cells, being denser than the plasma, are pushed toward the outside and the shape of the inner faces of the concave portions 5 directs them toward the inner faces of the convex portions 4 since the latter are situated over the largest diameter of the inner centrifuging space delimited by the inner face of the deflector 3.

As can be noted in FIGS. 2 and 4, the red blood cells RBC form layers confined to the inside of the kinds of truncated teeth formed by the convex portions 4 alternating with the re-entrant surfaces of the concave portions 5, while the plasma remains on a smaller centrifuging radius, adjacent to the inner surface of the layers of red blood cells RBC formed against the inner faces of the convex portions 4. The bottom or downstream ends 6 of the convex portions 4 are adjacent to the junction of the side wall 7 of the centrifuge chamber 1 and the bottom 13 of this chamber and are situated at a certain distance from this bottom 13. Preferably this distance is such that the downstream ends 6 are submerged in the layer of red blood cells RBC, namely in the layer formed by the constituent separated from the blood whose density is highest.

FIG. 2 shows that the downstream bottom end 6 of the convex portions 4 in which the red blood cells are concentrated is situated on the outside of the lower downstream ends 8 of the concave portions 5. Thanks to this arrangement, when the two components are already partially separated, the one that comprises essentially red blood cells RBC comes out of the downstream edge 6 of the deflector 3, at a diameter that is on the outside of that 8 from which the plasma PL comes out, removing the risks of remixing of the two components, since the red blood cells, which form the highest density particles, come out of the bottom of the deflector 3 close to the side wall 7 of the centrifuge chamber 1, against which they will rise again toward the discharge duct 11 while continuing to concentrate. The plasma PL for its part comes out along the bottom edges 8 of the concave portions 5, so that it is deposited inside the layer of red blood cells RBC while continuing to shed the heavier red blood cells that it still contains and that are pushed by the centrifugal force into the layer of red blood cells RBC gradually as the plasma flows in the direction of the inlet opening of the discharge duct 10.

The side wall 7 of the centrifuge chamber therefore acts as a second centrifuging stage. The plasma PL and the red blood cells RBC are finally extracted separately from the centrifuge chamber 1 by suction through their respective discharge ducts 10.

With reference to FIG. 4a, the latter illustrates, in a view similar to that of FIG. 4, a first variant of the cylindrical deflector 3. The convex portions 4 and the concave portions 5 form a succession of crenellations on the periphery of the cylindrical deflector 3, in particular at the periphery of the second conical portion 4″ of this deflector according to a preferred embodiment.

In another possible embodiment, FIG. 4b illustrates the convex portions 4 and the concave portions 5 forming a plurality of surfaces joined by ridges that are alternately re-entrant and protruding. The cylindrical deflector 3 obtained according to this second variant therefore has a body of a polyhedron or of a kind of pyramid having as its base a star-shaped surface. As is seen in this figure, the shape of the base of this body of a polyhedron is neither necessarily regular nor strictly concentric with the axis of revolution of the chamber. Therefore, it will be understood that the adjective “cylindrical” which qualifies the deflector 3 does not mean that the latter is restricted to having a perfectly circular shape. At least a portion of the ridges common to these surfaces are preferably convergent in their extension at a point situated on the axis of revolution of the chamber. This point of convergence corresponds to the virtual vertex of this body of a polyhedron that is preferably straight.

Like the illustrations given by FIGS. 4, 4a and 4b, note that the shapes that the convex portions 4 and concave portions 5 can take are extremely varied. Generally, it will be said therefore that the circular deflector 3 has alternating adjacent concave portions 5 and convex portions 4 that have or define between them crest or thalweg lines of which at least a portion of these lines are inclined in the direction of the axis of revolution of the chamber, preferably converging in their extension at a point situated on the axis of revolution of the chamber.

The crest lines correspond for example to the protruding ridges that were referred to in FIG. 4b, while the thalweg lines correspond conversely to the re-entrant ridges common to two adjacent surfaces in this figure, each of the convex portions 4 or concave portions 5 being able to be formed for example by a curved surface, by an angular surface or by a plurality of smooth and/or rough surfaces.

According to a preferred embodiment illustrated in particular in FIG. 3, the deflector is formed of two distinct parts, namely a top part consisting of the circular, slightly conical surface 4′ and a bottom part consisting of the second conical portion 4″. However, it will be mentioned that this deflector could equally see the circular surface 4′ as being a cylindrical surface, therefore with a constant radius over the whole of its height. In another variant, it would be equally possible to produce a cylindrical deflector 3 provided with a circular surface 4′ having an angle of conicity identical to that of the second conical portion 4″. In this case, the circular surface 4′ would be that of a cone, more precisely that of a frustoconical portion of a cone whose vertex would preferably be indistinguishable from the point of convergence of the crest or thalweg lines of the convex portions 4 and concave portions 5.

The effective centrifuging surface area of the centrifuge chamber 1 is equal to:

S=2·π·R₁·H+2·π·R₂·H=2·π·(R₁+R₂)·H

### Where:

H=effective height of the centrifuge chamber.

R1=effective average radius of the first centrifuging stage delimited by the deflector 3.

R2=effective average radius of the second centrifuging stage.

It is possible to note that this effective centrifuging surface area is very considerably greater than that of a conventional centrifuge chamber of identical space requirement, for which the effective centrifuging surface area is equal to:

S=2·π·R·H

To obtain maximum efficiency, it would be theoretically necessary for the radius R1 to tend toward R2 so that the surface area S obtained could be doubled. If, in practice, this value cannot be achieved, on the other hand it is possible to come close to it by placing the deflector 3 at an average distance from the side wall 7 of the chamber that preferably lies between 0.5 and 5 mm. In this manner, the thickness of the layer of red blood cells of the second stage of centrifuging would also be very thin. Advantageously, such a thin layer would make it possible to minimize the volume of red blood cells that remains trapped in the chamber and that would be lost at the end of the cycle after the use of the latter.

Ideally, the centrifuge chamber has a diameter of the order of 80 mm, an axial dimension (height) of the order of 100 mm, the flow being approximately 100 ml/min. These parameters may vary depending on the applications between 10 and 200 mm, preferably between 50 and 85 mm, for the diameter of the chamber and between 20 and 400 mm, preferably between 60 and 150 mm, for its height. As for its flow rate, it may vary between 10 and 1000 ml/min. In all cases, the present invention makes it possible to improve the performance of the centrifuge chamber having a given volume. This improvement results in an improvement in the separating power of the centrifuge chamber, making it possible to increase the flow rate of blood treated in a centrifuge chamber of the same volume, and at an unchanged speed of rotation.

According to the variant illustrated by FIG. 5, the centrifuge chamber 1 comprises a tubular or frustoconical filter 15 that is preferably a leucocyte filter placed concentrically with the axis of revolution of the centrifuge chamber 1. The diameter of this filter 15 is such that this filter is situated beneath the inner annular rim 3a of the deflector 3 and forms a central compartment 12 in the centrifuge chamber 1.

The whole blood WB comes out of the fixed feed duct 2 in the central compartment 12 close to the bottom of the centrifuge chamber 1. Thanks to the pressure loss due to the filter 15, the whole blood WB that comes out of the feed duct 2 is spread in a layer over the inner face of the filter 15. Because of the hydraulic pressure of the blood generated by the centrifugal force that is applied to it, the filtration of the blood is much more rapid than by simple gravity. This speed of filtration makes it possible to prevent a complete refilling of the compartment 12 which would lead to an interruption of the incoming flow of the whole blood WB. Once the blood has been filtered, it is sprayed by the centrifugal forces onto the wall of the deflector 3 and flows toward the bottom 13 of the centrifuge chamber 1. The rest of the separation process is then identical to that which was described with relation to the form of execution of FIGS. 2 to 4.

It is evident that this concept of a two-stage centrifuge chamber as described above may be enlarged to any number of centrifuging stages, by using, between each stage and the stage situated downstream, a deflector having in its downstream portion the same type of convex portions 4 alternating with concave portions 5 as the deflector 3.

The same process may be used for the separation of whole blood into more than two components (acellular plasma, thrombocytic concentrate, red blood cell concentrate, white blood cell concentrate, etc.). The process of inserting whole blood and drawing off the separated components may be envisaged both continuously (all the separated components being drawn off simultaneously with the insertion of the blood to be separated) and discontinuously (only a portion of the separated components being drawn off simultaneously with the insertion of blood, the other component(s) being drawn off after the centrifuge has been stopped).

The process described above can be applied for purposes of apheresis, separation of blood constituents from collection pouches, or else washing blood in the case of autotransfusion for example.

1. A circular centrifuge chamber for the separation of blood, this chamber being elongated along its axis of revolution and of which one of the ends has a sealing means around a fixed portion concentric with its axis of revolution, this chamber being traversed by a feed channel for the blood to be centrifuged and at least one discharge channel for the constituent separated from the blood whose density is the lowest, these feed and discharge channels being designed to be connected to means for circulating the blood from one to the other of these channels through the centrifuge chamber while forming an axial flow against the circular side wall of this chamber, the discharge channel having an inlet opening that is at a distance from said axis of revolution corresponding to the zone of concentration of said separated constituent whose density is the lowest in order to continuously remove it, at least one circular deflector being situated between the outlet of the feed channel and the inlet opening of the discharge channel in order to form an axial flow of the blood with a counter-current of that formed against said side wall, characterized in that the circular deflector has alternating adjacent concave portions and convex portions that have or define between them crest or thalweg lines of which at least a portion of these lines are inclined in the direction of the axis of revolution of the chamber.

2. The centrifuge chamber as claimed in claim 1, wherein said portions of the crest or thalweg lines are, in their extension, converging at a point situated on the axis of revolution of the chamber.

3. The centrifuge chamber as claimed in claim 1, wherein the concave portions and convex portions are fitted to the downstream perimeter of a circular surface of the circular deflector.

4. The centrifuge chamber as claimed in claim 3, wherein the circular surface is cylindrical, conical or frustoconical.

5. The centrifuge chamber as claimed in claim 3, wherein the circular surface is that of a frustoconical portion of a cone whose vertex is indistinguishable from the point of convergence of the crest or thalweg lines of the convex portions and concave portions.

6. The centrifuge chamber as claimed in claim 1, wherein a tubular or frustoconical filter is placed inside said circular deflector.

7. The centrifuge chamber as claimed in claim 6, wherein the filter is a leucocyte filter.

8. The centrifuge chamber as claimed in claim 1, wherein the convex portions have downstream ends submerged in a layer formed of the constituent separated from the blood whose density is the highest.

9. The centrifuge chamber as claimed in claim 1, whose diameter lies between 10 and 200 mm and whose height lies between 20 and 400 mm.

10. The centrifuge chamber as claimed in claim 9, whose diameter lies between 50 and 85 mm and whose height lies between 60 and 150 mm.

11. The centrifuge chamber as claimed in claim 1, wherein the upstream end of said deflector has an annular rim that extends toward the inside in order to separate the flow of blood entering from the flow of separated constituents.

12. The centrifuge chamber as claimed in claim 1, wherein the deflector is at an average distance lying between 0.5 and 5 mm from the side wall.
